(19) United States
(12) Patent Application Publication
(10) Pub. No.: US 2026/0277195 A1
(43) Pub. Date: Sep. 17, 2026

(54) SYSTEMS AND METHODS FOR APPLYING FILM TO A PANEL

(71) Applicant: Ford Global Technologies, LLC, Dearborn, MI (US)

(72) Inventors: Jeff Tornabene, Canton, MI (US); Brandon Tolsma, Bloomdale, OH (US); Jason Ryska, Allen Park, MI (US); Benjamin Zabicki, Ferndale, MI (US)

(73) Assignee: Ford Global Technologies, LLC, Dearborn, MI (US)

(21) Appl. No.: 19/080,104

(22) Filed: Mar. 14, 2025

(51) Int. Cl. G05B 19/418

(52) U.S. Cl. CPC G05B 19/41835; G05B 19/41895

(57) ABSTRACT

A method for applying a film to one or more components of a vehicle as part of an automated vehicle manufacturing process include the receipt of the one or more components from an autonomously guided vehicle at a vacuum chamber, the determination of one or more specifications associated with a component of the one or more components, the selection of the film from a plurality of films, and the application of the selected film to the component.

### FIELD

The present disclosure relates to systems and methods directed toward a film application process that one or more components of a vehicle undergo during a manufacturing production. More specifically, the present disclosure relates to a vacuum-based, and autonomous, means for applying film to the one or more components.

### BACKGROUND

The statements in this section merely provide background information related to the present disclosure and may not constitute prior art.

A film can be applied to one or more body panels of a vehicle either in a vehicle manufacturing process or in an aftermarket setting. Within the vehicle manufacturing process, the film is applied to the one or more body panels using heat activation of an adhesive of the film, having the film extended from a roll of film, as well as using air pressure to apply the film to the one or more body panels. However, present processes related to the application of film to body panels has inefficiencies.

The present disclosure addresses these and other issues related to systems and methods for a film application process.

### SUMMARY

This section provides a general summary of the disclosure and is not a comprehensive disclosure of its full scope or all of its features.

The present disclosure provides a method for applying a film to one or more components of a vehicle as part of an automated vehicle manufacturing process, wherein the method comprises: receiving, at a vacuum chamber associated with a manufacturing facility, the one or more components from an autonomously guided vehicle; determining one or more specifications associated with a component of the one or more components; selecting the film from a plurality of films that corresponds to the one or more specifications associated with the component; and applying the selected film to the component; wherein applying the selected film to the component includes the vacuum chamber vertically engaging with the component, and wherein the vacuum chamber is associated with a centralized vacuum generation system; wherein selecting the film from the plurality of films is based on a color that corresponds to the one or more specifications associated with the component, a style that corresponds to the one or more specifications associated with the component, or a combination thereof; further comprising: autonomously loading the component into the vacuum chamber in response to determining the one or more specifications associated with the component; and autonomously removing the component from the vacuum chamber in response to applying the selected film to the component; further comprising: pre-cutting the film based on the one or more specifications associated with the component; and autonomously loading the film into the vacuum chamber in response to selecting the film; further comprising: pre-cleaning the component in response to determining the one or more specifications associated with the component, wherein pre-cleaning the component includes applying a pressurized air to the component, a vacuum to the component, a brush cleaning to the component, or a combination thereof; and further comprising: performing an autonomous visual inspection of the component in response to applying the selected film to the component; determining whether there are any anomalies associated with the application of the selected film to the component; and causing the component to be autonomously guided to a repair station in response to determining that there are one or more anomalies associated with the application of the selected film to the component.

The present disclosure provides a system comprising: a manufacturing facility configured to apply a film to one or more components of a vehicle as part of an automated vehicle manufacturing process; and a vacuum chamber associated with the manufacturing facility configured to: receive the one or more components from an autonomously guided vehicle, determine one or more specifications associated with a component of the one or more components, select the film from a plurality of films that corresponds to the one or more specifications associated with the component, and apply the selected film to the component, wherein the application of the selected film to the component includes the vacuum chamber vertically engaging with the component, and wherein the vacuum chamber is associated with a centralized vacuum generation system; wherein the selection of the film from the plurality of films is based on a color that corresponds to the one or more specifications associated with the component, a style that corresponds to the one or more specifications associated with the component, or a combination thereof; wherein the vacuum chamber is further configured to: autonomously load the component into the vacuum chamber in response to determining the one or more specifications associated with the component; and autonomously remove the component from the vacuum chamber in response to the application of the selected film to the component; wherein the vacuum chamber is further configured to: pre-cut the film based on the one or more specifications associated with the component; and autonomously load the film into the vacuum chamber in response to selecting the film; wherein the vacuum chamber is further configured to: pre-clean the component in response to determining the one or more specifications associated with the component, wherein pre-cleaning the component includes applying a pressurized air to the component, a vacuum to the component, a brush cleaning to the component, or a combination thereof; and wherein the manufacturing facility is further configured to: perform an autonomous visual inspection of the component in response to applying the selected film to the component; determine whether there are any anomalies associated with the application of the selected film to the component; and cause the component to be autonomously guided to a repair station in response to determining that there are one or more anomalies associated with the application of the selected film to the component.

The present disclosure provides one or more non-transitory computer-readable media storing processor-executable instructions that, when executed by at least one processor, cause the at least one processor to: receive, at a vacuum chamber associated with a manufacturing facility, one or more components from an autonomously guided vehicle; determine one or more specifications associated with a component of the one or more components; select a film from a plurality of films that corresponds to the one or more specifications associated with the component; and apply the selected film to the component; wherein the application of the selected film to the component includes the vacuum chamber vertically engaging with the component, and wherein the vacuum chamber is associated with a centralized vacuum generation system; wherein the selection of the film from the plurality of films is based on a color that corresponds to the one or more specifications associated with the component, a style that corresponds to the one or more specifications associated with the component, or a combination thereof; wherein the at least one processor is further caused to: autonomously load the component into the vacuum chamber in response to determining the one or more specifications associated with the component; and autonomously remove the component from a vacuum chamber in response to the application of the selected film to the component; wherein the at least one processor is further caused to: pre-cut the film based on the one or more specifications associated with the component; and autonomously load the film into the vacuum chamber in response to selecting the film; wherein the at least one processor is further caused to: pre-clean the component in response to determining the one or more specifications associated with the component, wherein pre-cleaning the component includes applying a pressurized air to the component, a vacuum to the component, a brush cleaning to the component, or a combination thereof; and wherein the at least one processor is further caused to: perform an autonomous visual inspection of the component in response to applying the selected film to the component; determine whether there are any anomalies associated with the application of the selected film to the component; and cause the component to be autonomously guided to a repair station in response to determining that there are one or more anomalies associated with the application of the selected film to the component.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 depicts an overall process flow of an example method in accordance with one or more embodiments of the present disclosure;

FIG. 2 depicts an overall system associated with a vacuum chamber in accordance with one or more embodiments of the present disclosure;

FIG. 3 is a flowchart illustrating an example method for a film application process in accordance with one or more embodiments of the present disclosure;

FIG. 4 is a flowchart illustrating another example method for a film application process in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a means for integrating a film application process into a vehicle build process. In one or more examples, the integration of the film application process into the vehicle build process can include loading one or more body panels, or related parts, into an assembly line from a rack or an automated robot that directly enters the assembly line providing for an automated unload process.

The present disclosure also provides a means for an enhanced part pre-cleaning process. In one or more examples, the part pre-cleaning process can include one or more methods for ensuring that parts are prepared for a cleaning process to prevent contamination and/or inclusions, using a plurality of methods including, but not limited to, pressurized air, vacuum, and/or brush cleaning.

The present disclosure additionally provides a means for utilizing film in an enhanced way. For example, one or more embodiments provide for reducing excess film, pre-engineering a shape that is pre-cut and specific to each part using a laser, a physical blade, or other means, forming each pre-cut film to each part, as well as holding multiple rolls of film in a trimming operation utilized to select an appropriate color/style and quickly change between materials from part to part as needed.

The present disclosure further provides a means for part-specific tooling used to maximize film utilization as well as minimize the time required to generate a vacuum pressure. In one or more examples, the tooling specific to each part is designed and/or built such that the film is held tightly just outside the confines of the part, which minimizes the amount of film used. As another example, the vacuum pressure is generated solely within a chamber of the part-specific tool, which reduces a volume of air to be evacuated, thereby enhancing cycle time.

Additional advantages the present disclosure provides includes, but are not limited to, the vertical opening and closing of the chamber; the automation of the load and unload process; the automation of a film removal process after an automated trimming (e.g., via the use of a robot) and use of conveyance to remove excess film from the assembly line; the utilization of a centralized vacuum generation system to generate a stronger vacuum pressure with faster cycle time compared to a much smaller vacuum pump dedicated individually to each separate assembly line; the automated re-introduction of parts applied to the same vehicle to ensure proper sequencing in the assembly process; and/or a mega-cell concept for vehicle assembly and scaling with volume.

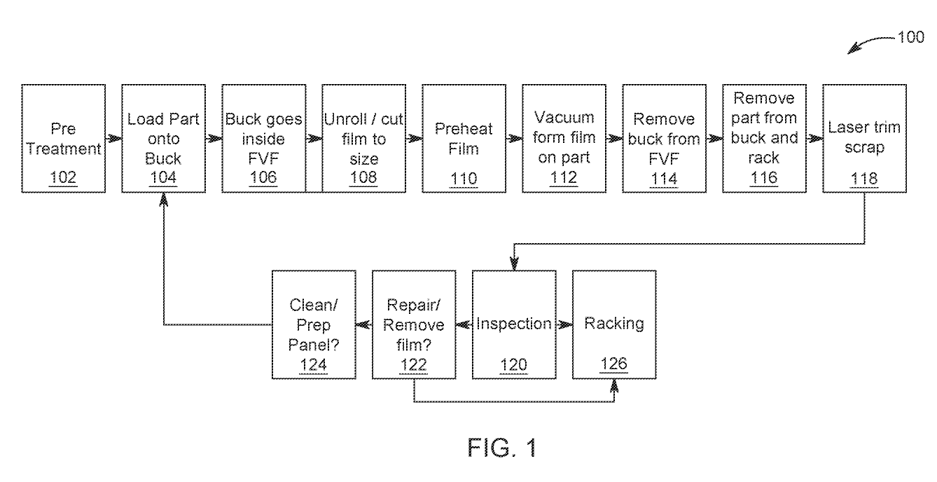

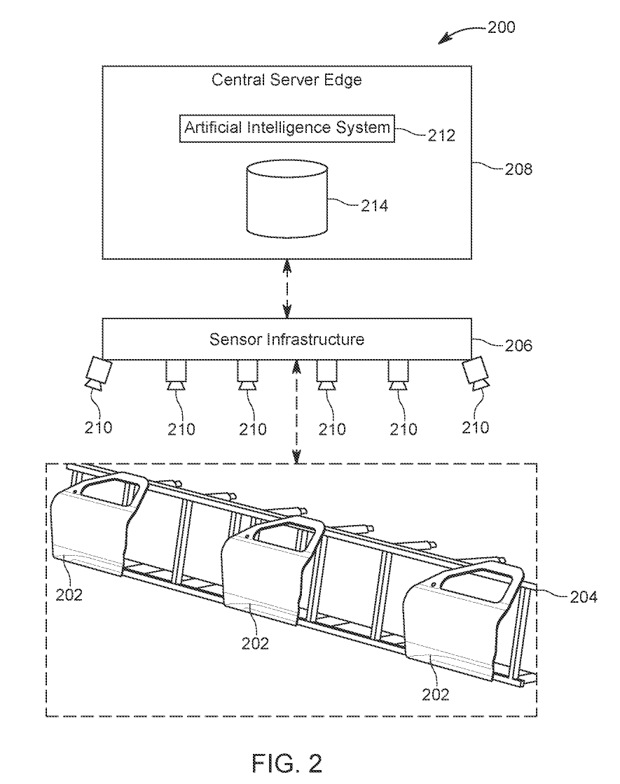

FIG. 1 shows an example pathway 100 associated with a film application process that one or more components (e.g., one or more components 202 shown in FIG. 2) of a vehicle (not shown) undergoes as part of an overall manufacturing process. However, it is understood that the example pathway 100 associated with the film application process is not required to be part of the overall manufacturing process and instead can be an isolated process and/or part of any other type of overall process. The example pathway 100 is generally comprised of one or more operational steps related to the application of film to the one or more components 202 of the vehicle. For example, the one or more operational steps can include a pre-treatment step 102, a component loading step 104, a buck loading step 106, a film cutting step 108, a pre-heating step 110, a film forming step 112, a buck removal step 114, a component removal step 116, a trimming step 118, and an inspection step 120, as described in more detail herein. However, fewer or additional operational steps of the same or different type are contemplated.

With reference to FIG. 2, an example embodiment of a vacuum chamber 200 associated with a manufacturing facility is illustrated. In one or more examples, the vacuum chamber 200 is configured to perform at least each of the one or more operational steps (e.g., the pre-treatment step 102, the component loading step 104, the buck loading step 106, the film cutting step 108, the pre-heating step 110, the film forming step 112, the buck removal step 114, the component removal step 116, the trimming step 118, and the inspection step 120). As another example, FIG. 2 illustrates an assembly line 204 configured to move the one or more components 202 through the vacuum chamber 200 and/or through other areas of the manufacturing facility. The vacuum chamber 200 generally includes at least one sensor infrastructure 206 connected to at least a central edge server 208. In one or more examples, the central edge server 208 is connected to the at least one sensor infrastructure 206 via a wireless means, a wired means, or a combination thereof.

The central edge server 208 is configured to utilize sensor data received from the at least one sensor infrastructure 206 to track a progression of the one or more components 202 through the film application process. The at least one sensor infrastructure 206 includes a set of infrastructure sensors 210 such as, for example, a two-dimensional (2D) camera, a three-dimensional (3D) camera, an infrared sensor, a radar scanner, a laser scanner, a light detection and ranging (LIDAR) sensor, an ultrasonic sensor, among others. The set of infrastructure sensors 210 are configured to monitor the progression of the one or more components 202 through the film application process, as is described herein. The set of infrastructure sensors 210 are also configured to aid in the performance of one or more inspections of the one or more components 202 through the film application process, as is also described herein. It is understood, however, that other functionalities of the one or more infrastructure sensors 210 related to the progression of the one or more components 202 through the film application process are contemplated as well.

Additionally, the central edge server 208 is configured to utilize an artificial intelligence system 212, that is included within the central edge server 208, to optimize the film application process, as is described herein. In one or more examples, the artificial intelligence system 212 can be internal (e.g., as shown in FIG. 2) to the central edge server 208 or external relative to the central edge server 208 (e.g., within the sensor infrastructure 206 or an infrastructure system (not shown) that the central edge server 208 may be configured to communicate with). It is understood that the artificial intelligence system 212 is configured to utilize any form of machine learning and/or implementation of neural networking to make one or more predictions, analyses, and/or determinations as is described herein. In one or more embodiments, the artificial intelligence system 212 is also configured to communicate with one or more sensors disposed within the vacuum chamber 200 and/or included as part of the sensor infrastructure 206. In one or more examples, the artificial intelligence system 212 is configured to measure input data related to the film and/or the environment of the film application. As another example, the artificial intelligence system 212 is also configured to process output data as well as utilize any form of machine learning to adjust one or more machine parameters (e.g., related to at least the vacuum chamber 200) in real-time to optimize all aspects of the film application process, as is described herein. It is understood that any of the measurement of the input data, the processing of the output data, and/or the adjustment to the one or more machine parameters is performed based on obtained data received from the one or more sensors as utilized by the artificial intelligence system 212.

Referring back to FIG. 1, upon entry of the one or more components 202 to the vacuum chamber 200, the pre-treatment step 102 of the film application process is initiated. In one or more examples, the vacuum chamber 200 is configured to prepare a surface (e.g., a body panel) of the one or more components 202 for application of the film as part of the pre-treatment step 102. For example, the pre-treatment step 102 can include cleaning the surface of the one or more components 202. It is understood that the surface of the one or more components 202 can be cleaned by any method such as, but not limited to, an application of pressurized air, vacuuming, and/or brush cleaning. It is also understood that the chosen method for cleaning the one or more components 202 can include the application of any material to the one or more components 202. It is further understood that any material utilized in the pre-treatment step 102 is relied upon as an aid to the chosen method by which the one or more components 202 are cleaned in preparation of the application of the film to the surface of the one or more components 202.

In one or more examples, the progression of the one or more components 202 through the pre-treatment step 102 is monitored by the one or more infrastructure sensors 210. It is understood that the sensor data can be stored in a database 214 and is based on one or more images acquired by the one or more infrastructure sensors 210 associated with monitoring the progression of the one or more components 202 through the pre-treatment step 102. For example, while the database 214 is depicted (in FIG. 2) as disposed internally within the central edge server 208, the database 214 can be externally disposed in relation to the central edge server 208 as well. It is also understood that the pre-treatment step 102 can be repeated any number of times based on the sensor data received from the one or more infrastructure sensors 210.

In one or more examples, the artificial intelligence system 212 can determine whether the pre-treatment step 102 should be repeated based on one or more historical entries. As another example, the database 214 is configured to store the one or more historical entries that are based on previous determinations made by the artificial intelligence system 212 regarding an evaluation(s) of whether the surface of the one or more components 202 is sufficiently clean. As yet another example, the determination of whether the surface of the one or more components 202 is sufficiently clean can be based on a threshold related to a detection of a predetermined number of anomalies present on the surface of the one or more components 202 and detected by the artificial intelligence system 212 (e.g., via the one or more infrastructure sensors 210). For example, the artificial intelligence system 212 determines that the surface of the one or more components 202 is not sufficiently clean in a case wherein the threshold related to detection of the predetermined number of anomalies present on the surface of the one or more components 202 is met or exceeded. As another example, the artificial intelligence system 212 determines that the surface of the one or more components 202 is sufficiently clean in a case wherein the predetermined number of anomalies present on the surface of the one or more components 202 does not meet or exceed the threshold related to the detection of the predetermined number of anomalies present on the surface of the one or more components 202.

In an instance wherein the artificial intelligence system 212 determines that the surface of the one or more components 202 is sufficiently clean, the one or more components 202 are loaded onto a vehicle buck (not shown) at the component loading step 104. In one or more examples, an autonomously guided robot (not shown) is configured to autonomously load the one or more components 202 onto the vehicle buck. As another example, the vehicle buck is a physical representation corresponding to the one or more components 202 that provides the vacuum chamber 200 with a basis to enhance accuracy related to cutting the film, as is discussed herein.

Once the one or more components 202 are loaded onto the vehicle buck, the vehicle buck is inserted into the vacuum chamber 200 at the buck loading step 106. In one or more examples, the autonomously guided robot is also configured to autonomously insert the vehicle buck into the vacuum chamber 200. It is understood that the autonomously guided robot configured to insert the vehicle buck into the vacuum chamber 200 can be the same robot as the autonomously guided robot configured to load the one or more components 202 onto the vehicle buck or a different robot. As yet another example, the vacuum chamber 200 is configured to vertically open and close to accept the vehicle buck therein. It is understood that the vertically configured system provided by the present film application process is advantageous in comparison to horizontally configured systems and other types of systems, which result in inefficiencies within other film application processes.

Once the vehicle buck is inserted into the vacuum chamber 200, the vacuum chamber is configured to cause the film to be unrolled and cut to size at the film cutting step 108. As an example, the film can be unrolled from a turret that is able to hold multiple rolls of film that can accommodate the selection of a color that corresponds to one or more specifications associated with the one or more components 202, a style that corresponds to the one or more specifications associated with the one or more components 202, or a combination thereof. In one or more examples, the artificial intelligence system 212 is configured to analyze one or more dimensions of the vehicle buck (e.g., via the one or more infrastructure sensors 210) to determine an amount of the film to be unrolled. As another example, the determination of the amount of the film to be unrolled is based on the one or more dimensions of the vehicle buck. As yet another example, the artificial intelligence system 212 is configured to determine the amount of the film to be unrolled in real-time (e.g., based on the sensor data received from the one or more infrastructure sensors 210) or based on historical data stored in the database 214. As a further example, the historical data can represent previously made cuts to the film that correspond to a particular identification number unique to different components. As yet another example, the artificial intelligence system 212 is also configured to cause the vacuum chamber 200 to autonomously adjust the unrolling of the film based on one or more factors such as, but not limited to, an outside diameter of the roll of film, the amount of the film to be unrolled, or other film disbursement-related factors.

The film that is cut to size is then pre-heated at the pre-heating step 110 and formed to the one or more components 202 via the film forming step 112. In one or more examples, the vacuum chamber 200 is configured to perform the pre-heating step 110 by heating the film that is cut to size to a predetermined temperature. For example, the predetermined temperature used as a basis for heating the film that is cut to size is determined by the artificial intelligence system 212 based on the particular identification number unique to the different components and/or a chemical makeup of the film. In one or more examples, the vacuum chamber 200 is also configured to form the film that is cut to size to the surface of the one or more components 202 by applying a vacuum pressure to the one or more components 202. As an example, the vacuum chamber 200 can utilize a centralized vacuum generation system in its application of the vacuum pressure to the one or more components 202.

Once the film that is cut to size is formed onto the surface of the one or more components 202, the vehicle buck is removed from the vacuum chamber 200 at the buck removal step 114. In one or more examples, the autonomously guided robot is further configured to autonomously remove the vehicle buck from the vacuum chamber 200. It is understood that the autonomously guided robot configured to remove the vehicle buck from the vacuum chamber 200 can be the same robot as the autonomously guided robot configured to insert the vehicle buck into the vacuum chamber 200 and/or the autonomously guided robot configured to load the one or more components 202 onto the vehicle buck. However, it is also understood that the autonomously guided robot configured to remove the vehicle buck from the vacuum chamber 200 can be different than the autonomously guided robot configured to insert the vehicle buck into the vacuum chamber 200 and/or the autonomously guided robot configured to load the one or more components 202 onto the vehicle buck.

The one or more components 202 are then removed from the vehicle buck at the component removal step 116. In one or more examples, the autonomously guided robot is further configured to autonomously remove the one or more components 202 from the vehicle buck. It is understood that the autonomously guided robot configured to remove the one or more components 202 from the vehicle buck can be the same robot as the autonomously guided robot configured to insert the vehicle buck into the vacuum chamber 200, the autonomously guided robot configured to load the one or more components 202 onto the vehicle buck, and/or the autonomously guided robot configured to remove the vehicle buck from the vacuum chamber 200. However, it is understood that the autonomously guided robot configured to remove the one or more components 202 from the vehicle buck can be different than the autonomously guided robot configured to insert the vehicle buck into the vacuum chamber 200, the autonomously guided robot configured to load the one or more components 202 onto the vehicle buck, and/or the autonomously guided robot configured to remove the vehicle buck from the vacuum chamber 200.

Any excess film is then removed from the one or more components 202 at the trimming step 118. In one or more examples, the artificial intelligence system 212 is configured to determine whether excess film should be removed from the one or more components 202 (e.g., via the one or more infrastructure sensors 210). As an example, the excess film is removed through the application of a laser to the excess film. However, it is understood that the excess film may be removed from the one or more components 202 utilizing any means.

Once the excess film is removed from the one or more components 202, the one or more components 202 are inspected at the inspection step 120. In one or more examples, the artificial intelligence system 212 is configured to perform an inspection of the one or more components 202 (e.g., via the one or more infrastructure sensors 210). As an example, the inspection of the one or more components 202 can be autonomous and provide the artificial intelligence system 212 with the means to determine whether any anomalies are present upon and/or within (e.g., between the film and the surface of the one or more components 202) the film applied to the one or more components 202. In an instance wherein the artificial intelligence system 212 determines that one or more anomalies are present upon and/or within the film applied to the one or more components 202, the artificial intelligence system 212 is configured to cause the one or more components 202 to be moved to a repair workstation (not shown) at a repair step 122. As an example, the one or more components 202 can be caused to move via a conveyance utilized in the assembly line 204 or using an autonomously guided robot. As another example, the determination of whether the one or more anomalies are present upon and/or within the film applied to the one or more components 202 can be based on a level of repair that may be required to address the one or more anomalies.

The artificial intelligence system 212 is further configured to communicate with the repair workstation and determine whether the film can be repaired or if the film should be removed from the one or more components 202. In a case wherein the film is removed from the one or more components 202, the artificial intelligence system 212 is configured to cause the surface of the one or more components 202 to be cleaned once again (e.g., similar to how the surface of the one or more components was cleaned in the pre-treatment step 102), at a re-cleaning step 124, in preparation of repeating the component loading step 104 and ultimately progressing through the film application process once more (e.g., the buck loading step 106, the film cutting step 108, the preheating step 110, the film forming step 112, the buck removal step 114, the component removal step 116, the trimming step 118, and the inspection step 120). However, in a case wherein the film is not removed and the artificial intelligence system 212 determines that the one or more anomalies have been repaired at the repair workstation, the artificial intelligence system 212 is configured to cause the one or more components 202 to be moved to a racking station (not shown) at a racking step 126.

Alternatively, and at the inspection step 120, in a case wherein the artificial intelligence system 212 determines that no anomalies are present upon and/or within the film applied to the one or more components 202, the artificial intelligence system 212 is configured to cause the one or more components 202 to be moved to the racking station at the racking step 126. In one or more examples, the racking step 126 can include one or more steps for storing the one or more components 202 in an accessible manner so that the one or more components 202 may ultimately be installed on the vehicle progressing through the manufacturing process as part of an assembly of the vehicle.

While the one or more components 202 may be subjected to the film application process as is described herein, it is understood that each of the operations related to the film application process (e.g., the pre-treatment step 102, the component loading step 104, the buck loading step 106, the film cutting step 108, the preheating step 110, the film forming step 112, the buck removal step 114, the component removal step 116, the trimming step 118, and the inspection step 120) may be completed within the vacuum chamber 200 or at different workstations positioned in relation to the vacuum chamber 200.

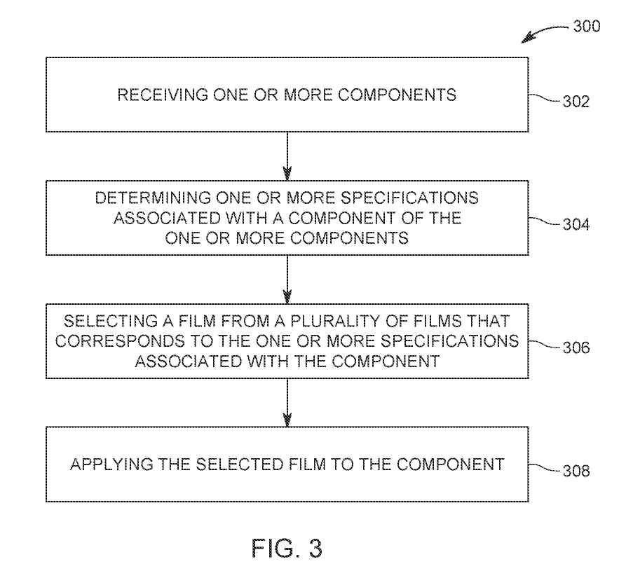

FIG. 3 is a flowchart illustrating an example method 300 applicable for implementation by a manufacturing facility to apply a film to one or more components (e.g., the one or more components 202) of a vehicle as part of an automated vehicle manufacturing process. At operation 302, a vacuum chamber (e.g., the vacuum chamber 200) associated with the manufacturing facility is configured to receive the one or more components from an autonomously guided vehicle. At operation 304, the vacuum chamber is also configured to determine one or more specifications associated with a component of the one or more components.

At operation 306, the vacuum chamber is additionally configured to select the film from a plurality of films that corresponds to the one or more specifications associated with the component. In one or more examples, the selection of the film from the plurality of films is based on a color that corresponds to the one or more specifications associated with the component, a style that corresponds to the one or more specifications associated with the component, or a combination thereof.

At operation 308, the vacuum chamber is further configured to apply the selected film to the component. In one or more embodiments, the application of the selected film to the component includes the vacuum chamber vertically engaging with the component. In one or more examples, the vacuum chamber is associated with a centralized vacuum generation system.

In one or more embodiments, the vacuum chamber is configured to autonomously load the component therein. The vacuum chamber is also configured to autonomously remove the component from within. In one or more examples, the component is autonomously loaded in response to determining the one or more specifications associated with the component. As another example, the component is autonomously removed in response to applying the selected film to the component.

In one or more embodiments, the vacuum chamber is configured to pre-cut the film as well as autonomously load the film therein. In one or more examples, the pre-cutting of the film is based on the one or more specifications associated with the component. As another example, the film is autonomously loaded in response to selecting the film.

In one or more embodiments, the vacuum chamber is further configured to pre-clean the component. In one or more examples, the pre-cleaning of the component is performed in response to determining the one or more specifications associated with the component. As another example, the pre-cleaning of the component includes applying a pressurized air to the component, a vacuum to the component, a brush cleaning to the component, or a combination thereof.

In one or more embodiments, the vacuum chamber is additionally configured to perform an autonomous visual inspection of the component. However, it is understood that the vacuum chamber is configured to perform the autonomous inspection of the component utilizing any means for scanning the component such as, but not limited to, ultrasonic and/or thermal scanning technologies. In one or more examples, the autonomous visual inspection is performed in response to applying the selected film to the component. The vacuum chamber is also configured to determine whether there are any anomalies associated with the application of the selected film to the component. The vacuum chamber is further configured to cause the component to be autonomously guided to a repair station in response to identifying one or more anomalies. That is, in one or more examples, the autonomous guidance of the vehicle to the repair station is caused in response to determining that there are one or more anomalies associated with the application of the selected film to the component.

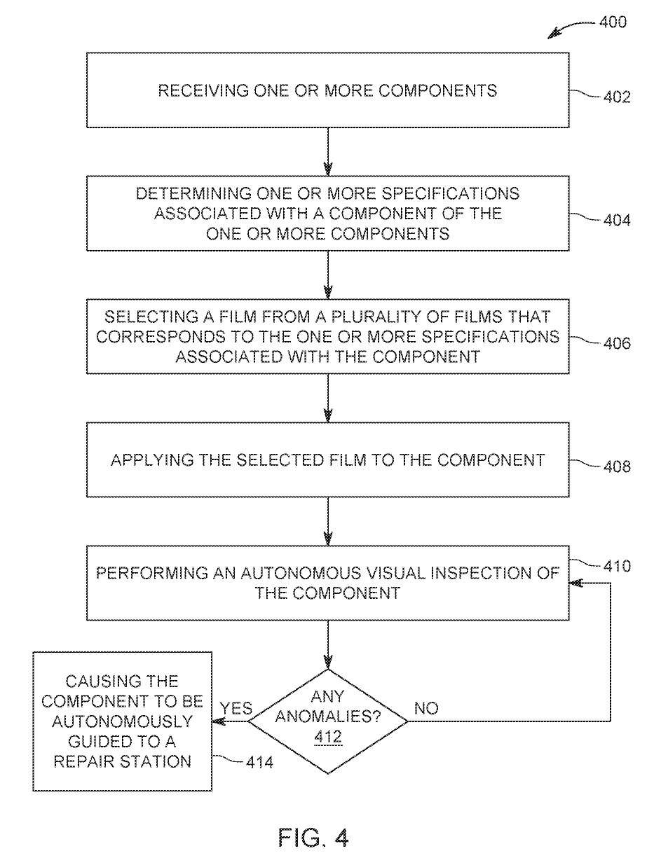

FIG. 4 is a flowchart illustrating an example method 400 applicable for implementation by a manufacturing facility to apply a film to one or more components (e.g., the one or more components 202) of a vehicle as part of an automated vehicle manufacturing process. At operation 402, a vacuum chamber (e.g., the vacuum chamber 200) associated with the manufacturing facility is configured to receive the one or more components from an autonomously guided vehicle. At operation 404, the vacuum chamber is also configured to determine one or more specifications associated with a component of the one or more components.

At operation 406, the vacuum chamber is additionally configured to select the film from a plurality of films that corresponds to the one or more specifications associated with the component. In one or more examples, the selection of the film from the plurality of films is based on a color that corresponds to the one or more specifications associated with the component, a style that corresponds to the one or more specifications associated with the component, or a combination thereof.

At operation 408, the vacuum chamber is further configured to apply the selected film to the component. In one or more embodiments, the application of the selected film to the component includes the vacuum chamber vertically engaging with the component. In one or more examples, the vacuum chamber is associated with a centralized vacuum generation system.

At operation 410, the vacuum chamber is also configured to perform an autonomous visual inspection of the component. In one or more examples, the autonomous visual inspection is performed in response to applying the selected film to the component.

At operation 412, the vacuum chamber is configured to determine whether there are any anomalies associated with the application of the selected film to the component. In an instance wherein one or more anomalies are determined as being present upon and/or within (e.g., between the film and the surface of the component) the film applied to the component, the vacuum chamber is configured to cause the component to be autonomously guided to a repair station at operation 414. However, in an instance wherein the one or more anomalies are determined to be not present upon and/or within the film applied to the component, the autonomous visual inspection (e.g., at operation 410) is repeated until the vacuum chamber causes the component to be racked (e.g., stored in an accessible manner, such as in a rack, so that the component may ultimately be installed on the vehicle progressing through the manufacturing process as part of an assembly of the vehicle).

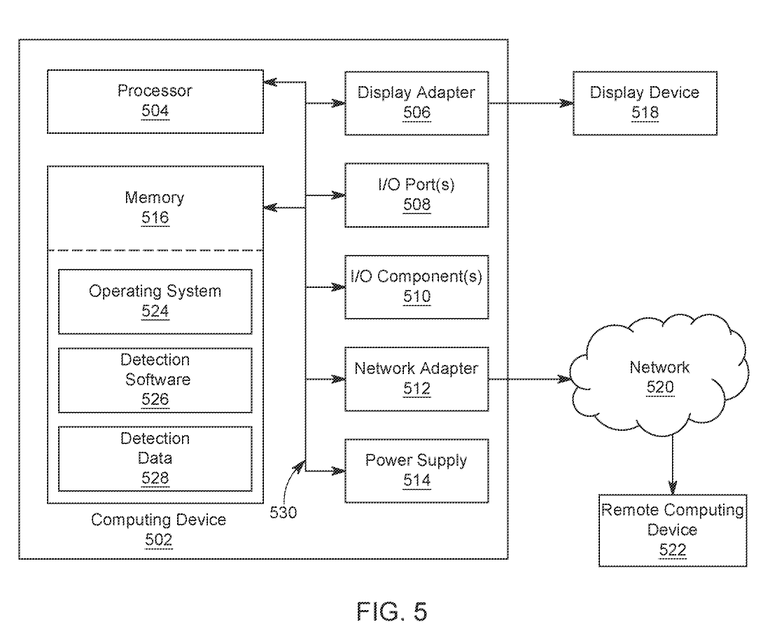

FIG. 5 illustrates an operating environment, such as a computer system, that facilitates the performance of one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, RAM, or a combination thereof. The memory 516 is configured to provide storage for instructions and data associated with the operation of the computing device 502. The memory 516 can generally include an operating system 524, detection software 526, and detection data 528 to perform one or more operations described in more detail herein. For example, the operating system 524 is configured to manage and/or process any of the data and/or instructions associated with the detection software 526 and/or the detection data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provide a means for applying a film to one or more body panels of a vehicle through a film application process. In one or more examples, an artificial intelligence system associated with a vacuum chamber guides the one or more body panels through a dynamic, and adaptive, film application process that provides at least one or more advantages over existing film application processes.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

As used herein, a step or operation of a method can be used interchangeably and refer to any process performed by the method.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for applying a film to one or more components of a vehicle as part of an automated vehicle manufacturing process, wherein the method comprises:
receiving, at a vacuum chamber associated with a manufacturing facility, the one or more components from an autonomously guided vehicle;
determining one or more specifications associated with a component of the one or more components;
selecting the film from a plurality of films that corresponds to the one or more specifications associated with the component; and
applying the selected film to the component.

2. The method of claim 1, wherein applying the selected film to the component includes the vacuum chamber vertically engaging with the component, and wherein the vacuum chamber is associated with a centralized vacuum generation system.

3. The method of claim 1, wherein selecting the film from the plurality of films is based on a color that corresponds to the one or more specifications associated with the component, a style that corresponds to the one or more specifications associated with the component, or a combination thereof.

4. The method of claim 1, further comprising:
autonomously loading the component into the vacuum chamber in response to determining the one or more specifications associated with the component; and
autonomously removing the component from the vacuum chamber in response to applying the selected film to the component.

5. The method of claim 1, further comprising:
pre-cutting the film based on the one or more specifications associated with the component; and
autonomously loading the pre-cut film into the vacuum chamber in response to selecting the film.

6. The method of claim 1, further comprising:
pre-cleaning the component in response to determining the one or more specifications associated with the component, wherein pre-cleaning the component includes applying a pressurized air to the component, a vacuum to the component, a brush cleaning to the component, or a combination thereof.

7. The method of claim 1, further comprising:
performing an autonomous visual inspection of the component in response to applying the selected film to the component;
determining whether there are any anomalies associated with the application of the selected film to the component; and
causing the component to be autonomously guided to a repair station in response to determining that there are one or more anomalies associated with the application of the selected film to the component.

8. A system comprising:
a manufacturing facility configured to apply a film to one or more components of a vehicle as part of an automated vehicle manufacturing process; and
a vacuum chamber associated with the manufacturing facility configured to:
receive the one or more components from an autonomously guided vehicle,
determine one or more specifications associated with a component of the one or more components,
select the film from a plurality of films that corresponds to the one or more specifications associated with the component, and
apply the selected film to the component, wherein the application of the selected film to the component includes the vacuum chamber vertically engaging with the component, and wherein the vacuum chamber is associated with a centralized vacuum generation system.

9. The system of claim 8, wherein the selection of the film from the plurality of films is based on a color that corresponds to the one or more specifications associated with the component, a style that corresponds to the one or more specifications associated with the component, or a combination thereof.

10. The system of claim 8, wherein the vacuum chamber is further configured to:
autonomously load the component into the vacuum chamber in response to determining the one or more specifications associated with the component; and
autonomously remove the component from the vacuum chamber in response to the application of the selected film to the component.

11. The system of claim 8, wherein the vacuum chamber is further configured to:
pre-cut the film based on the one or more specifications associated with the component; and
autonomously load the pre-cut film into the vacuum chamber in response to selecting the film.

12. The system of claim 8, wherein the vacuum chamber is further configured to:
pre-clean the component in response to determining the one or more specifications associated with the component, wherein pre-cleaning the component includes applying a pressurized air to the component, a vacuum to the component, a brush cleaning to the component, or a combination thereof.

13. The system of claim 8, wherein the manufacturing facility is further configured to:
perform an autonomous visual inspection of the component in response to applying the selected film to the component;
determine whether there are any anomalies associated with the application of the selected film to the component; and
cause the component to be autonomously guided to a repair station in response to determining that there are one or more anomalies associated with the application of the selected film to the component.

14. One or more non-transitory computer-readable media storing processor-executable instructions that, when executed by at least one processor, cause the at least one processor to:
receive, at a vacuum chamber associated with a manufacturing facility, one or more components from an autonomously guided vehicle;
determine one or more specifications associated with a component of the one or more components;
select a film from a plurality of films that corresponds to the one or more specifications associated with the component; and
apply the selected film to the component.

15. The one or more non-transitory computer-readable media of claim 14, wherein the application of the selected film to the component includes the vacuum chamber vertically engaging with the component, and wherein the vacuum chamber is associated with a centralized vacuum generation system.

16. The one or more non-transitory computer-readable media of claim 14, wherein the selection of the film from the plurality of films is based on a color that corresponds to the one or more specifications associated with the component, a style that corresponds to the one or more specifications associated with the component, or a combination thereof.

17. The one or more non-transitory computer-readable media of claim 14, wherein the at least one processor is further caused to:
autonomously load the component into the vacuum chamber in response to determining the one or more specifications associated with the component; and
autonomously remove the component from a vacuum chamber in response to the application of the selected film to the component.

18. The one or more non-transitory computer-readable media of claim 14, wherein the at least one processor is further caused to:
pre-cut the film based on the one or more specifications associated with the component; and
autonomously load the pre-cut film into the vacuum chamber in response to selecting the film.

19. The one or more non-transitory computer-readable media of claim 14, wherein the at least one processor is further caused to:
pre-clean the component in response to determining the one or more specifications associated with the component, wherein pre-cleaning the component includes applying a pressurized air to the component, a vacuum to the component, a brush cleaning to the component, or a combination thereof.

20. The one or more non-transitory computer-readable media of claim 14, wherein the at least one processor is further caused to:
perform an autonomous visual inspection of the component in response to applying the selected film to the component;
determine whether there are any anomalies associated with the application of the selected film to the component; and
cause the component to be autonomously guided to a repair station in response to determining that there are one or more anomalies associated with the application of the selected film to the component.
